(19) United States
(12) Patent Application Publication
(10) Pub. No.: US 2026/0200399 A1
(43) Pub. Date: Jul. 16, 2026

(54) AUTOMATIC MIRROR ADJUSTMENT SYSTEM FOR VEHICLE

(71) Applicant: GM GLOBAL TECHNOLOGY OPERATIONS LLC, Detroit, MI (US)

(72) Inventors: Cameron G. LaCourt, Royal Oak, MI (US); Tyler C. Hanson, Clawson, MI (US); Joseph Hong, Wolverine Lake, MI (US)

(73) Assignee: GM GLOBAL TECHNOLOGY OPERATIONS LLC, Detroit, MI (US)

(21) Appl. No.: 19/016,187

(22) Filed: Jan. 10, 2025

(51) Int. Cl. B60R 1/072; B60R 1/12

(52) U.S. Cl. CPC B60R 1/072; B60R 1/12; B60R 2001/1223

(57) ABSTRACT

An automatic mirror adjustment system for a driver in a vehicle has a tracking device configured to obtain vision data of the driver in real time. The driver is seated in a vehicle seat. The vehicle includes one or more mirror assemblies each having a respective mirror, the respective mirror being movable along at least two dimensions from an initial mirror setting. A controller is adapted to obtain a respective spatial location of the tracking device, the respective spatial location of a predefined reference point on the vehicle seat, the respective spatial location of an ocular reference point of the driver based in part on the vision data. The controller is adapted to determine an optimal mirror orientation for the respective mirror and execute control commands to adjust the respective mirror to the optimal mirror orientation.

### INTRODUCTION

The present disclosure relates generally to an automatic mirror adjustment system for a vehicle. It is an undeniable facet of modern life that many people spend a considerable amount of time in their vehicles, while being transported from one place to another. The vehicle is equipped with various elements to assist the driver, for example, mirrors help drivers see around their vehicle. Vehicle mirrors serve as an extension of a driver's vision, enabling them to monitor surrounding traffic without having to turn their head. The side mirrors indicate vehicles or objects in adjacent lanes, while the rearview mirror provides an awareness of rear traffic. This allows a driver to make better decisions when changing lanes, merging, or changing speed. The angle or orientation of the mirror is generally adjusted by the driver manually or through electric controls (e.g., buttons on the door panel).

### SUMMARY

Disclosed herein is an automatic mirror adjustment system for a driver in a vehicle. The vehicle includes one or more mirror assemblies each having a respective mirror. The respective mirror is movable along at least two dimensions from an initial mirror setting. The system includes a controller adapted to receive the vision data, the controller having a processor and tangible, non-transitory memory on which instructions are recorded. The controller is adapted to obtain a respective spatial location of an ocular reference point of the driver based in part on the vision data, and the respective spatial location of a predefined reference point on the vehicle seat that the driver is seated on. The controller is adapted to obtain the respective spatial location of the tracking device.

The controller is adapted to determine an optimal mirror orientation for the respective mirror and execute control commands to adjust the respective mirror to the optimal mirror orientation. The optimal mirror orientation is based in part on the respective spatial location of the tracking device, the ocular reference point, and the predefined reference point on the vehicle seat.

When the driver has two functioning eyes, the ocular reference point is selected to be a midpoint of a line joining the two functioning eyes. When the driver has a single functioning eye, the ocular reference point is selected to be a center of the single functioning eye. The optimal mirror orientation for the respective mirror may be selected such that a mirror normal line bisects an angle between an incident line of sight and a reflected line of sight. The mirror normal line is perpendicular to a surface of the respective mirror. The incident line of sight extends from the ocular reference point towards a pivot point in the respective mirror. The reflected line of sight extends from the pivot point towards a defined target point.

The respective mirror may include a rear-view mirror positioned inside an interior of the vehicle and a side view mirror positioned on an exterior surface of the vehicle. In some embodiments, the predefined reference point on the vehicle seat is selected to be a Hip-Point of the vehicle seat. The system may include a proximity sensor adapted to detect presence of an object within a predefined distance of an exterior surface of the vehicle. The controller is adapted to execute the control commands to move the respective mirror to increase visibility of the object.

The controller may be adapted to update the optimal mirror orientation when the vehicle is shifting out of or into a driving mode of operation. When the vehicle is in a reverse mode of operation, the controller is adapted to execute the control commands to move the respective mirror to increase visibility of a blind spot region. In some embodiments, the tracking device includes a source and a camera. The source is adapted to emit infrared light, with the camera being adapted to detect the infrared light reflected by at least one eye of the driver. The tracking device may be positioned on a steering wheel assembly in the vehicle.

A key fob may be adapted to store the initial mirror setting associated with the driver, the controller being adapted to execute the control commands to move the respective mirror to the initial mirror setting when the key fob is in proximity to the vehicle. The system may include a face recognition module accessible by the controller and adapted to store face profile data associated with the driver. The vision data of the driver is linked with the face profile data such that previously acquired sets of the vision data are accessible to the controller when the driver is recognized by the face recognition module.

Disclosed herein is a method of operating an automatic mirror adjustment system in a vehicle having a controller with a processor and tangible, non-transitory memory, and one or more mirror assemblies each with a respective mirror. The method includes obtaining vision data in real-time of a driver seated in a vehicle seat, via a tracking device in communication with controller. The respective mirror is movable along at least two dimensions from an initial mirror setting. The method includes determining a respective spatial location of an ocular reference point of the driver based in part on the vision data, obtaining the respective spatial location of a predefined reference point on the vehicle seat, and obtaining the respective spatial location of the tracking device. The method includes determining an optimal mirror orientation for the respective mirror based in part on the respective spatial location of the tracking device, the ocular reference point, and the predefined reference point on the vehicle seat. The method includes executing control commands to adjust the respective mirror to the optimal mirror orientation, via the controller.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary top view of a system for automatically adjusting one or more mirror assemblies in a vehicle;

FIG. 2 is a flowchart for a method for automatically adjusting one or more mirror assemblies in a vehicle;

FIG. 3 is a schematic fragmentary side view of the vehicle of FIG. 1; and

FIG. 4 is a schematic fragmentary top view of an example mirror assembly in the vehicle of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

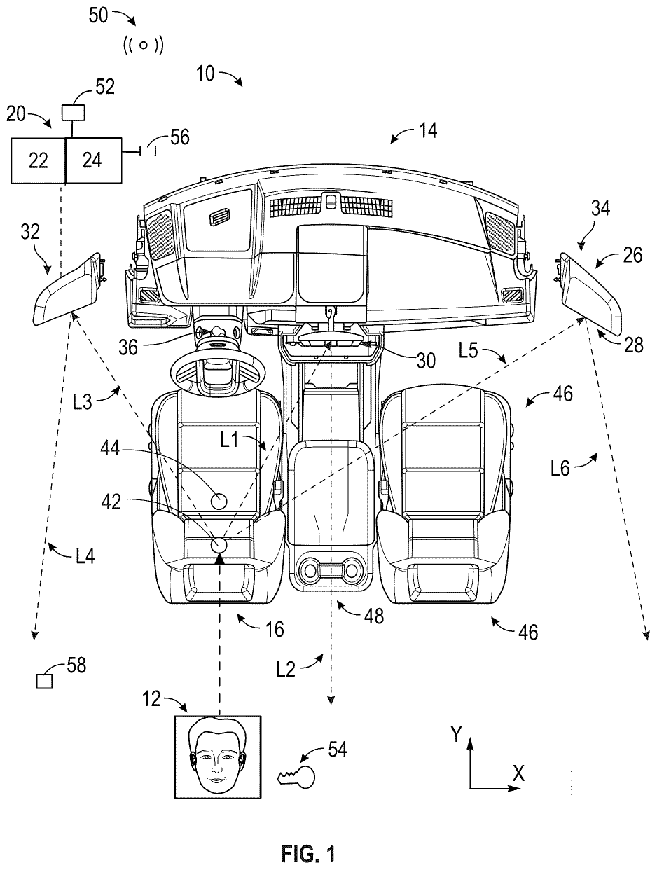

Referring to the drawings, wherein like reference numbers refer to like components, FIG. 1 schematically illustrates an automatic mirror adjustment system (referred to hereinafter as system 10) for a driver 12 in a vehicle 14. It is understood that the FIGS. are not drawn to scale. The driver 12 is seated in a vehicle seat 16. The vehicle 14 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 14 may be an electric vehicle. The vehicle 14 may be part of a fleet of autonomous vehicles. It is to be understood that the vehicle 14 may take many different forms and have additional components.

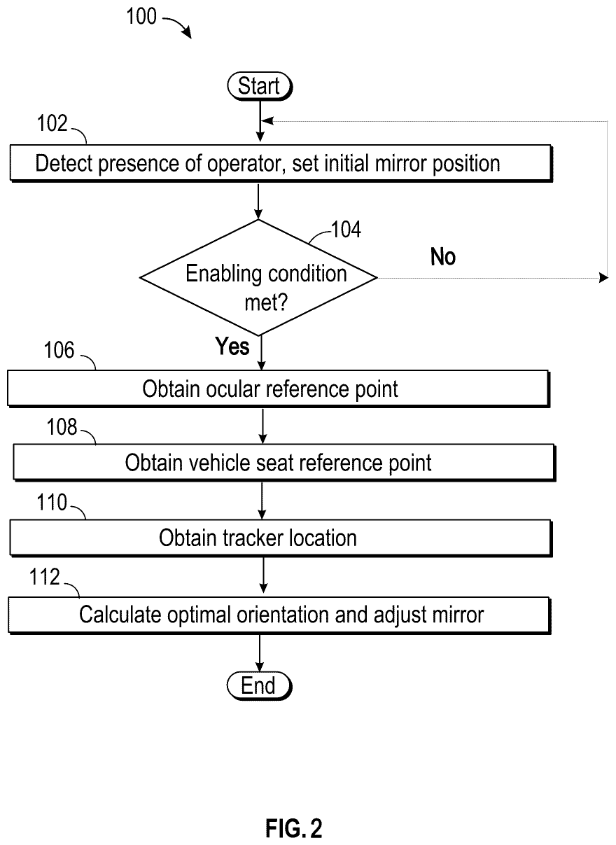

Referring to FIG. 1, the system 10 includes a controller 20 having at least one processor 22 and at least one memory 24 (or non-transitory, tangible computer readable storage medium) on which instructions are recorded for executing method 100 for operating the system 10 for automatically adjusting one or more mirror assemblies 26 in the vehicle 14. Method 100 is described below with reference to FIG. 2. The memory 24 can store executable instruction sets, and the processor 22 can execute the instruction sets stored in the memory 24.

Referring to FIG. 1, the mirror assemblies 26 each have a respective mirror 28 that is movable along at least two dimensions from an initial mirror setting. The initial mirror position is set based on previous or initial settings and then micro-adjusted (optimized) during transit. The mirror assemblies 26 include respective motors that move the respective mirror 28 in response to control commands from the controller 20. In some embodiments, the respective mirror 28 is connected to a motorized ball joint that is rotatable. The respective mirror 28 may include a rear-view mirror 30 positioned inside an interior of the vehicle 14 as well as a first side view mirror 32 and a second side view mirror 34 positioned on an exterior surface of the vehicle 14. The mirror assemblies 26 may include other mirrors positioned in or on the vehicle 14 and used for occupant visibility. The shape of the respective mirror 28 may be varied based on the application at hand and may include flat, concave and convex mirrors. Additionally, each mirror assembly 26 may include multiple mirrors within the same assembly, with each mirror being controlled via the methods described below.

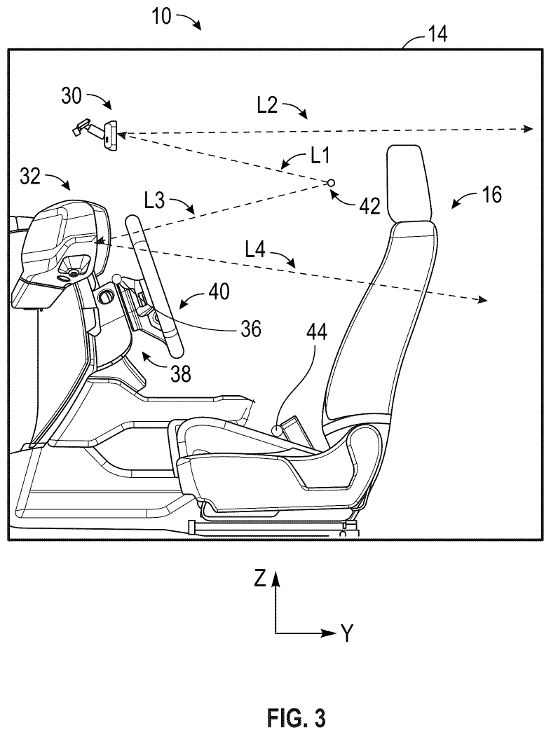

FIG. 3 is a schematic fragmentary side view of the vehicle 14. For example, the respective mirror 28 may be movable relative to an XY plane (side-to-side) and XZ plane (up and down). In this example, the X axis denotes a cross-car direction, the Y axis denotes a front-to-back direction while the Z axis (see FIG. 3) indicates a superior-inferior direction. Referring to FIGS. 1 and 3, the vehicle 14 utilizes an internal vehicle sensor, such as tracking device 36, to obtain vision data of the driver 12 in real time. Referring to FIG. 3, the tracking device 36 may be placed on a steering column 38 in a steering wheel assembly 40. Alternatively, the tracking device 36 may be placed on the dashboard of the vehicle 14. The tracking device 36 may be a camera-based system. In some embodiments, the tracking device 36 includes a source and a camera. Here, the source is adapted to emit infrared light, and the camera is adapted to detect the infrared light reflected by the eye(s) of the driver 12. It is understood that the tracking device 36 may incorporate other types of technologies available to those skilled in the art.

As described in detail below, the controller 20 is adapted to determine an optimal mirror orientation for the respective mirror 28 based in part on a respective spatial location of the tracking device 36, the respective spatial location of an ocular reference point 42 of the driver 12 based in part on the vision data, and the respective spatial location of a predefined reference point 44 on the vehicle seat 16. The controller 20 is adapted to execute control commands to dynamically adjust the respective mirror 28 to the optimal mirror orientation.

The system 10 elevates the driver's user experience by reducing setting changes and improving customization. Data is utilized for vehicle control setting customization such a change in mirror position for reverse based on driver movements and drive propulsion settings. The system 10 may employ body position tracking to make micro adjustments or adjustments to the respective mirror when the vehicle 14 is being reversed. By accurately tracking the eye movements of the driver 12 and adjusting the respective mirror 28 accordingly, the system 10 ensures the driver 12 has an ideal or optimal mirror orientation for maximum visibility and reduced blind spots without the need for pre-set positions or requiring manual adjustments.

Also shown in FIG. 1 is a passenger seat 46 and a center console 48. Communication between the various components of the system 10 may occur through a wireless network 50. In one embodiment, the controller 20 is embedded in the vehicle 14. In another embodiment, the controller 20 is stored in an “off-board” or remotely located cloud computing service. The cloud computing service may include one or more remote servers hosted on the Internet to store, manage, and process data.

Referring now to FIG. 2, a flowchart of an example method 100 is shown. Method 100 may be embodied as computer-readable code or instructions stored on and at least partially executable by the controller 20. Method 100 need not be applied in the specific order recited herein. Furthermore, it is to be understood that some blocks or steps may be eliminated. Method 100 may be executed in real-time, continuously, systematically, sporadically and/or at regular intervals during normal and ongoing operation of the vehicle 14. For example, the mirror assemblies 26 may be adjusted over a calibration period of vehicle operation (e.g., 3 minutes).

Beginning at block 102, the controller 20 is adapted to detect the presence of the driver 12 and set an initial mirror position Referring to FIG. 1, a portable device (such as a key fob 54) may be adapted to store an initial mirror setting associated with the driver 12 for each respective mirror 28. The controller 20 is adapted to execute control commands to move the respective mirror 28 to the initial mirror setting when the key fob 54 is in proximity (e.g., within a threshold distance) to the vehicle 14. The initial mirror settings are the dynamic mirror adjustment settings defined by the driver 12.

Advancing to block 104, the method 100 includes determining if at least one enabling condition is met. The enabling condition may include customer action via controls, such as enabling or disabling this feature from the vehicle controls. The enabling condition may be based on propulsion drive mode. The enabling condition may include a shift to and from park mode. If the enabling condition is met (block 104=YES), the method 100 advances to block 106. If the enabling condition is not met (block 104=NO), the method 100 loops back to block 102.

Per block 106, the controller 20 is programmed to identify a vision classification of the driver 12 based on the vision data, including whether the driver 12 has binocular vision or monocular vision. Monocular vision is characterized by one functioning eye and lacks the depth perception and three-dimensionality afforded by binocular vision. It is to be understood that the cutoff or threshold for determining whether an eye is sufficiently functioning may be varied based on the application at hand.

Per block 106, the controller 20 is adapted to extract an ocular reference point for the driver 12. If the driver 12 has a single functioning eye, the ocular reference point is selected to be the center of the functioning eye. If the driver 12 has two functioning eyes, the ocular reference point is selected to be a midpoint between the left eye and the right eye. The spatial location of the left eye and the right eye are defined by the tracking device 36, while the midpoint is calculated from a line connecting the spatial location of the left eye and the right eye.

The controller 20 may be adapted to employ eye ellipses for the purpose of defining the respective eye position of the driver 12 with reference to the vehicle 14. The eye ellipse results out of a set of lines that envelope and thus isolate an ellipse area. For example, the lines may divide the measured eye positions into 5% and 95% of the ellipse area. The tracking device 36 may be configured to target eye ellipse locations within the driver travel envelope. The tracking device 36 adapts to various powered seating positions and moves synchronously with the powered steering column, ensuring precise mirror position regardless of seating configuration.

Referring to FIGS. 1 and 3, lines L1 and L2 respectively indicate the line of sight from the ocular reference point 42 towards the rear-view mirror 30 and away from the rear-view mirror 30 towards a defined target point. Similarly, lines L3 and L4 respectively indicate the line of sight from the ocular reference point 42 towards and away from the first side view mirror 32. Referring to FIG. 1, lines L5 and L6 respectively indicate the line of sight from the ocular reference point 42 towards and away from the second side view mirror 34.

Referring to FIG. 1, the system may include a face recognition module 52 accessible by the controller 20 and adapted to store face profile data associated with the driver 12, including the vision classification. The face profile data may further include the height of the driver 12, the average eye position based on seat configuration, and other attributes of the driver 12. The system 10 allows specific driver attributes to define preset profiles for different drivers. The vision data of the driver 12 is linked with the face profile data such that previously acquired sets of the vision data are accessible to the controller 20 when the driver 12 is recognized by face recognition module 52. This provides an advantage of not having to run the calibration each time that a specific driver is driving.

Advancing from block 106 to block 108, the method 100 includes obtaining a predefined reference point 44 of the vehicle seat 16 that the driver 12 is seated on. In one embodiment, the predefined vehicle seat reference point is selected to be the “Hip-Point”. As understood by those skilled in the art, the Hip-Point of a vehicle seat refers to a theoretical pivot point between the torso and upper leg of a seated driver, representing approximately the center of the hip joint. Other points of reference for the vehicle seat may be selected based on the application at hand.

Proceeding from block 108 to block 110, the method 100 includes obtaining the spatial location of the tracking device 36, which is rigidly attached to a portion of the vehicle 14. This information would be accessible to the controller 20.

Advancing from block 110 to block 112, the method 100 includes determining an optimal mirror orientation for the respective mirror 28 based in part on the respective spatial location of the tracking device 36, the ocular reference point 42, and the predefined reference point 44 on the vehicle seat 16. The controller 20 is adapted to execute control commands to adjust the respective mirror 28 to the optimal mirror orientation.

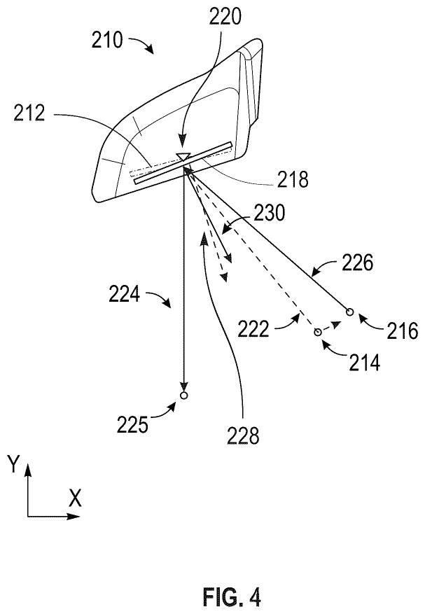

FIG. 4 is a schematic fragmentary top view of an example mirror assembly 210 having a mirror in a first mirror position 212 (shown in phantom) when the ocular reference point is the first spatial location 214. When the mirror is in the first mirror position 212, the first incident line 222 is a line of sight from the first spatial location 214 towards a pivot point 220 while the reflected line of sight 224 extends from the pivot point 220 towards a defined target point 225 in XYZ space. The pivot point 220 may be defined as the midpoint or center of the mirror. A first mirror normal 228 is defined to be at about 90 degrees from the surface of the mirror in the first mirror position 212 and extends from a midpoint of the mirror surface. The first mirror normal 228 bisects the angle between the first incident line 222 and the reflected line of sight 224.

Referring to FIG. 4, when the ocular reference point moves to a second spatial location 216 (i.e., the driver 12 moves), the controller 20 is adapted to move the mirror to a second mirror position 218 relative to the pivot point 220 in the mirror assembly 210. When the ocular reference point moves to a second spatial location 216, the incident line of sight to the pivot point 220 (or mirror center) is shifted from the first incident line 222 to a second incident line 226 while the reflected line of sight 224 towards the defined target point 225 remains constant. The mirror is rotated about the pivot point 220 such that a second mirror normal 230 (at 90 degrees from the surface of the mirror in the second mirror position 218) bisects the angle between the second incident line 226 and the reflected line of sight 224. The second mirror normal 230 extends from a midpoint of the mirror surface. As noted above, the shape of the mirror surface may be varied based on the application.

The controller 20 may be adapted to update the optimal mirror orientation when the vehicle 14 is shifting out of or into a driving mode of operation. For example, when the vehicle 14 is in a reverse mode of operation, the controller 20 may be adapted to execute control commands to move the respective mirror 28 to increase visibility of a blind spot region, i.e., make it easier for the driver 12 to view. This may be achieved by moving the respective mirror in downwards direction or along the Z axis between about 10 degrees and 30 degrees. The angle that the respective mirror 28 is moved depends in part on the shape and size of the vehicle body.

If the optimal mirror position entails more blind spot visibility and another vehicle indicator (such as a turn signal) is activated, the controller 20 may be adapted to execute control commands to move the respective mirror 28 to provide additional blind spot visibility by reducing the vehicle body in the mirror view.

In some embodiments, referring to FIG. 1, the vehicle 14 may include a proximity sensor 56 adapted to detect presence of an object 58 (e.g., a bird) within a predefined distance of an exterior surface of the vehicle 14. The controller 20 is adapted to execute control commands to move the respective mirror 28 to increase visibility of the detected object for the driver 12.

In summary, system 10 (via execution of method 100) integrates eye-tracking technology to create an adaptive user experience. This approach allows for real-time tracking of driver eye movements and dynamic adjustments to ensure the mirror positions are in the ideal position for maximum visibility and reducing blind spots. The integration of eye tracking with the mirror assembly 26 aligns precisely with the driver's position, enhancing usability, and reducing workload.

The wireless network 50 of FIG. 1 may be a communication BUS, which may be in the form of a serial Controller Area Network (CAN-BUS). The wireless network 50 may be a serial communication bus in the form of a local area network which may include, but is not limited to, a Controller Area Network (CAN), a Controller Area Network with Flexible Data Rate (CAN-FD), Ethernet, Bluetooth, WIFI and other forms of data. The wireless network 50 may be a Wireless Local Area Network (LAN) which links multiple devices using a wireless distribution method, or a Wireless Metropolitan Area Network (MAN). Other types of network technologies or communication protocols available to those skilled in the art may be employed.

The controller 20 of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a group of files in a file rechargeable energy storage system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products of various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based storage systems that perform the specified functions or acts, or combinations of specific purpose hardware and computer instructions. These computer program instructions may also be stored in a computer-readable medium that may direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used here indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An automatic mirror adjustment system for a driver in a vehicle having one or more mirror assemblies each having a respective mirror, the system comprising:
a tracking device configured to obtain vision data of the driver in real time, the respective mirror being movable along at least two dimensions from an initial mirror setting, the driver being seated in a vehicle seat;
a controller adapted to receive the vision data, the controller having a processor and tangible, non-transitory memory on which instructions are recorded;
wherein the controller is adapted to:
determine a respective spatial location of an ocular reference point of the driver based in part on the vision data;
obtain the respective spatial location of a predefined reference point on the vehicle seat;
obtain the respective spatial location of the tracking device;
determine an optimal mirror orientation for the respective mirror based in part on the respective spatial location of the tracking device, the ocular reference point, and the predefined reference point on the vehicle seat; and
execute control commands to adjust the respective mirror to the optimal mirror orientation.

2. The system of claim 1, wherein:
when the driver has two functioning eyes, the ocular reference point is a midpoint of a line joining the two functioning eyes; and
when the driver has a single functioning eye, the ocular reference point is a center of the single functioning eye.

3. The system of claim 1, wherein:
the optimal mirror orientation for the respective mirror is selected such that a mirror normal line bisects an angle between an incident line of sight and a reflected line of sight, the mirror normal line being perpendicular to a surface of the respective mirror; and
the incident line of sight extends from the ocular reference point towards a pivot point in the respective mirror, the reflected line of sight extending from the pivot point towards a defined target point.

4. The system of claim 1, wherein the respective mirror includes a rear-view mirror positioned inside an interior of the vehicle and a side view mirror positioned on an exterior surface of the vehicle.

5. The system of claim 1, wherein the predefined reference point on the vehicle seat is a Hip-Point of the vehicle seat, the vehicle includes a steering wheel assembly, the tracking device being positioned on the steering wheel assembly.

6. The system of claim 1, further comprising:
a proximity sensor adapted to detect presence of an object within a predefined distance of an exterior surface of the vehicle, the controller being adapted to execute the control commands to move the respective mirror to increase visibility of the object.

7. The system of claim 1, wherein the controller is adapted to update the optimal mirror orientation when the vehicle is shifting out of or into a driving mode of operation.

8. The system of claim 1, wherein when the vehicle is in a reverse mode of operation, the controller is adapted to execute the control commands to move the respective mirror to increase visibility of a blind spot region.

9. The system of claim 1, further comprising:
a key fob adapted to store the initial mirror setting associated with the driver, the controller being adapted to execute the control commands to move the respective mirror to the initial mirror setting when the key fob is in proximity to the vehicle.

10. The system of claim 1, further comprising:
a face recognition module accessible by the controller and adapted to store face profile data associated with the driver, the vision data of the driver being linked with the face profile data such that previously acquired sets of the vision data are accessible to the controller when the driver is recognized by the face recognition module.

11. The system of claim 1, wherein the tracking device includes a source and a camera, the source being adapted to emit infrared light, and the camera being adapted to detect the infrared light reflected by at least one eye of the driver.

12. A method of operating an automatic mirror adjustment system in a vehicle having a controller with a processor and tangible, non-transitory memory, and one or more mirror assemblies each with a respective mirror, the method comprising:
obtaining vision data in real-time of a driver seated in a vehicle seat, via a tracking device in communication with controller, the respective mirror being movable along at least two dimensions from an initial mirror setting;
determining a respective spatial location of an ocular reference point of the driver based in part on the vision data;
obtaining the respective spatial location of a predefined reference point on the vehicle seat;
obtaining the respective spatial location of the tracking device;
determining an optimal mirror orientation for the respective mirror based in part on the respective spatial location of the tracking device, the ocular reference point, and the predefined reference point on the vehicle seat, via the controller; and
executing control commands to adjust the respective mirror to the optimal mirror orientation, via the controller.

13. The method of claim 12, further comprising:
selecting the predefined reference point on the vehicle seat to be a Hip-Point of the vehicle seat; and
selecting the optimal mirror orientation for the respective mirror such that a mirror normal line bisects an angle between an incident line of sight and a reflected line of sight, the mirror normal line being perpendicular to a surface of the respective mirror, the incident line of sight extending from the ocular reference point towards a pivot point in the respective mirror, the reflected line of sight extending from the pivot point towards a defined target point.

14. The method of claim 12, further comprising:
detecting presence of an object within a predefined distance of an exterior surface of the vehicle through a proximity sensor and executing the control commands to move the respective mirror to increase visibility of the object, via the controller.

15. The method of claim 12, further comprising:
updating the optimal mirror orientation, when the vehicle is shifting out of or into a driving mode of operation, via the controller, including executing the control commands to move the respective mirror to increase visibility in a blind spot region when the vehicle is in a reverse mode of operation.

16. The method of claim 12, further comprising:
storing the initial mirror setting associated with the driver in a key fob, and executing the control commands to move the respective mirror to the initial mirror setting when the key fob is in proximity to the vehicle, via the controller.

17. The method of claim 12, further comprising:
storing face profile data associated with the driver in a face recognition module, the vision data of the driver being linked with the face profile data such that previously acquired sets of the vision data are accessible to the controller when the driver is recognized by the face recognition module.

18. A vehicle comprising:
an automatic mirror adjustment system for a driver seated in a vehicle seat, the vehicle having one or more mirror assemblies each having a respective mirror;
a tracking device configured to obtain vision data of the driver in real time, the respective mirror being movable along at least two dimensions from an initial mirror setting, the driver being;
a controller with a processor and tangible, non-transitory memory on which instructions are recorded, the controller being adapted to receive the vision data;
wherein the controller is adapted to:
determine a respective spatial location of an ocular reference point of the driver based in part on the vision data;
obtain the respective spatial location of a predefined reference point on the vehicle seat;
obtain the respective spatial location of the tracking device;
determine an optimal mirror orientation for the respective mirror based in part on the respective spatial location of the tracking device, the ocular reference point, and the predefined reference point on the vehicle seat; and
execute control commands to adjust the respective mirror to the optimal mirror orientation.

19. The vehicle of claim 18, wherein:
when the driver has two functioning eyes, the ocular reference point is selected to be a midpoint of the two functioning eyes;
when the driver has a single functioning eye, the ocular reference point is selected to be a center of the single functioning eye;
the optimal mirror orientation for the respective mirror is selected such that a mirror normal line bisects an angle between an incident line of sight and a reflected line of sight, the mirror normal line being perpendicular to a surface of the respective mirror; and
the incident line of sight extends from the ocular reference point towards a pivot point in the respective mirror, the reflected line of sight extending from the pivot point towards a defined target point.

20. The vehicle of claim 19, further comprising:
a proximity sensor adapted to detect presence of an object within a predefined distance of an exterior surface of the vehicle, the controller being adapted to execute the control commands to move the respective mirror to increase visibility of the object; and
wherein the controller is adapted to update the optimal mirror orientation when the vehicle is shifting out of or into a driving mode of operation, including executing the control commands to move the respective mirror to increase the visibility of a blind spot region when the vehicle is in a reverse mode of operation.
